(19) United States
(12) Patent Application Publication
(10) Pub. No.: US 2014/0300797 A1
(43) Pub. Date: Oct. 9, 2014

(54) DIGITAL CAMERA

(71) Applicant: Arnold & Richter Cine Technik GmbH & Co. 8etriebs KG, Munich (DE)

(72) Inventor: Klaus Jacumet, Munchen (DE)

(73) Assignee: Arnold & Richter Cine Technik GmbH & Co. 8etriebs KG, Munich (DE)

(21) Appl. No.: 14/230,362

(22) Filed: Mar. 31, 2014

(30) Foreign Application Priority Data
Apr. 8, 2013 (DE) DE 102013206169.2

(51) Int. Cl. H04N 5/232

(52) U.S. Cl. CPC H04N 5/23212
USPC 348/345

(57) ABSTRACT

A digital camera, in particular a motion picture camera, comprises an objective mount for connecting an objective and an image sensor, wherein the image sensor and the objective are arranged along an optical axis of the camera. The camera furthermore comprises an adjustment apparatus, which is adapted to adjust the distance between the objective mount and the image sensor along the optical axis, and a control unit having at least one operating parameter signal input for receiving at least one operating parameter value of the camera or of a connected objective. The control unit is adapted to determine a desired distance value between the objective mount and the image sensor on the basis of the at least one operating parameter value and to control the adjustment apparatus to set the distance between the objective mount and the image sensor to the desired distance value.

The present invention relates to a digital camera, in particular to a motion picture camera, having an objective mount for connecting an objective and having an image sensor, wherein the image sensor and the objective are arranged along an optical axis of the camera.

The objective mount defines a contact plane for the objective to be connected. The image sensor extends along a light-sensitive sensor plane, with the sensor plane corresponding to the image plane of the optical arrangement. As a rule, the contact plane and the sensor plane extend perpendicular to the optical axis of the camera, with it, however, not being precluded that the angle of the contact plane and/or of the sensor plane is able to be varied with respect to the optical axis, which can be utilized, for example, for a geometrical image rectification. The distance between the contact plane and the sensor plane forms the so-called flange focal distance of the camera.

A rotatable objective ring which is provided with a distance scale is frequently provided to set the image sharpness. So that an object which is located at a distance which corresponds to the set distance value on the distance scale is also actually imaged in focus, it is necessary for the actual flange focal distance to correspond to the flange focal distance for which the respective objective was designed. The tolerances of the flange focal distance should amount to no more than ±0.01 mm so that a focused imaging in accordance with the set distance value is ensured. A correct flange focal distance is in particular necessary with a distance setting at “infinity” since a focusing on “infinity” would thus not otherwise be possible under certain circumstances due to a mechanical limitation of the focus adjustment range of the objective.

The flange focal distance required for an exact focusing can depend on various underlying conditions in the operation of the camera so that at times differences between the set distance value in accordance with the distance scale of the objective and the actual distance of the object to be imaged occur and/or no ideal focusing takes place.

It is therefore the object of the present invention to provide a digital camera which allows an improved focusing.

The object is satisfied by a digital camera having the features of claim 1. The digital camera in accordance with the invention comprises an adjustment apparatus which is adapted to adjust the distance between the objective mount and the image sensor along the optical axis. The camera furthermore comprises a control unit having at least one operating parameter signal input for receiving at least one operating parameter value of the camera or of a connected objective, with the control unit being adapted to determine a desired distance value between the objective mount and the image sensor on the basis of the at least one operating parameter value and to control the adjustment apparatus to set the distance between the objective mount and the image sensor to the desired distance value.

With the camera in accordance with the invention, the setting of the distance between the objective mount and the image sensor, that is the setting of the flange focal distance, to the desired distance value takes place automatically in response to the named operating parameter value. The operating parameter value is a value which characterizes an instantaneous operating state of the camera. The named operating parameter value in particular differs from a set focal value or from a desired focal value of the connected objective, i.e. the setting of the desired distance value does not directly serve for the focusing in response to a focal value, but rather for a compensation of an incorrect or suboptimal flange focal distance in response to an instantaneous operating state of the camera. Examples for possible operating parameter values will be explained in even more detail in the following. A complex manual adaptation of the flange focal distance, for instance by an underlaying of leveling shims between the objective and the objective mount, is not required.

The connected objective can, for example, comprise a focus setting device for setting the focal value of the objective, with in particular a manual or semiautomatic setting of the focal value being able to be provided. The setting of the focal value can take place, for example, by means of an electric motor which rotates an objective ring and which is controlled on the basis of a corresponding preset of a cameraman or of an assistant. The setting of the distance between the objective mount and the image sensor in contrast does not serve for the setting of the focal value, but rather only for the correction or compensation of unwanted effects during the operation of the camera. These effects can, for example, be temperature effects or aperture-dependent spherical aberration of the objective.

In accordance with an advantageous embodiment of the invention, the adjustment apparatus is adapted to displace the image sensor along the optical axis. Although it is generally also possible to displace the objective mount with the aid of the adjustment apparatus, a displacement of the image sensor makes smaller construction and technical production demands on the adjustment apparatus.

It is preferred in this connection if the maximum displacement path of the image sensor amounts to at most 250 μm. Generally, a small displacement path is provided and sufficient since the displacement of the image sensor does not serve for the setting of the focal position, but rather only for the correction or compensation of unwanted effects during the operation of the camera. A simple and nevertheless exact actuator, for example a piezo element, can thus be provided for the adjustment apparatus.

The control unit is advantageously adapted to determine the desired distance value such that the image sharpness of an object imaged on the image sensor is at a maximum for a given focal setting of the objective. A mean image distance varying due to optical errors of the objective (e.g. spherical aberration, chromatic aberration) and/or due to varying operating states of the camera or of the objective can hereby be compensated such that the image sharpness is always optimum overall.

In accordance with an advantageous embodiment of the invention, the named operating parameter value comprises a set f-number or a desired f-number of the connected objective. In this case, the connected objective has a settable objective aperture for setting a desired f-number. The flange focal distance is changed in dependence on the f-number.

It is of advantage in this connection if the control unit is adapted to determine the desired distance value such that the image sharpness of an object imaged on the image sensor is at a maximum for the set f-number or for the desired f-number of the connected objective. The circumstance is thereby taken into account that almost every objective has more or less spherical aberration. This spherical aberration has the effect that light rays emanating from a specific object point are not combined at a single image point after the passage through the objective, but rather come together at a plurality of image points within a specific back focal length range. The respective back focal length or position along the optical axis of a specific image point in this respect depends on the ray height, i.e. on the radius (distance from the optical axis) of that circular lens zone which generates this image point. Ultimately, the spherical aberration therefore produces an image blur, with as a rule an ideal image distance (arrangement of the light-sensitive sensor plane) being able to be found at which a maximum total image sharpness is present. Since the image points for a small set f-number, i.e. of a large diaphragm aperture, are on average located in a different distance range or back focal length range than the image points for a high set f-number, i.e. of a smaller opening aperture of the objective diaphragm, the ideal image length can be displaced in dependence on the f-number, i.e. with a given focal setting, the range of the maximum image sharpness varies slightly along the optical axis in dependence on the set f-number or on the desired f-number. This variation can be compensated by a corresponding control of the adjustment apparatus without a change of the focal setting being required on a change of the f-number.

Provision can be made for this purpose that the named operating parameter signal input of the control unit is connected to an objective data interface which is provided at the objective mount of the camera to receive the set f-number from the connected objective. In this respect, the objective can have an f-number sensor which is adapted to generate an f-number signal on the basis of the set f-number and to output it (directly or via a data store) to the objective data interface of the camera. The set f-number can in particular be part of a set of data which are output from the objective via an interface (e.g. in accordance with the ARRI Lens Data System).

The named operating parameter value can further more comprise a focal length value of the connected objective in addition to the set f-number. In this case, the value of the fixed focal length or of the set focal length of the connective objective can be transmitted via the objective data interface to the operating parameter signal input of the control unit. If the objective has a fixed focal length, the objective can have a memory device in which the focal length value is stored.

Alternatively or additionally to the named connection with an objective data interface, the named operating parameter signal input of the control unit can be adapted to receive the desired f-number of the connected objective from an external objective control unit which controls the connected objective from external. The external objective control unit can be a remote control unit, for example, which controls a motor unit which engages at the outside of the connected objective and which in particular sets the desired f-number at the objective diaphragm. The desired f-number is thus the f-number set from external, i.e. a corresponding control signal, with a corresponding f-number sensor not necessarily having to be provided for a regulation with feedback.

In accordance with an embodiment of the invention, the camera comprises a filter element between the objective mount and the image sensor. The filter element can, for instance, be a planoparallel plate which influences the optical path, for example a low pass filter, a neutral density filter (ND filter), an ultraviolet filter or an infrared filter, which can in particular be fixedly installed or which can selectively be moved or pivoted into the optical path. Since the objectives which can be used with a specific camera are frequently designed for an optical path within the camera without such a filter element, the effects on the position of the image points and in particular on the dependence of the image point displacement on the ray height, i.e. on the distance from the optical axis, have to be compensated. In the case of a presence of such a filter element, a correction of the flange focal distance in dependence on the f-number is particularly advantageous, in particular when the filter element is fixedly installed.

The named operating parameter value can in particular also comprise a filter element recognition value, with the camera comprising at least one filter element detector which is adapted to generate the filter element recognition value when a filter element (in particular the filter element already explained above) is present in a region between the objective mount and the image sensor. The named operating parameter signal input of the control unit is connected to the filter element detector to receive the filter element recognition value. Accordingly, the control unit is adapted to determine the desired distance value while taking account of the filter element recognition value, in particular also in addition to the above-explained taking into account of the f-number. The filter element recognition value can be a binary value in accordance with the status “filter element present” or “filter element absent”.

However, the filter element detector can also be adapted to detect information on the kind of the filter element and/or on at least one optical property of the filter element, with the filter element recognition value comprising this information. Exemplary optical properties are in this connection the thickness and/or the refractive index of the filter element. The filter element detector can detect the said information, for example, in that it determines the desired information from a look-up table on the basis of a filter element recognition which allows a clear identification of the filter element. Alternatively, the information can also be stored in a memory provided at the filter element.

The filter element detector is advantageously adapted to determine independently whether a filter element is present in the region between the objective mount and the image sensor. This determination can in particular take place via an optical, mechanical or electrical sensor. Alternatively, the filter element detector can have a user-actuated input device which is adapted to detect information at least on the presence of a named filter element, preferably also information on at least one optical property of the named filter element.

In accordance with a further advantageous embodiment of the invention, the named operating parameter value comprises a temperature value, with the camera comprising a temperature sensor which is adapted to generate the temperature value on the basis of a detected temperature, and with the named operating parameter signal input of the control unit being connected to the temperature sensor to receive the temperature value. The control unit is therefore adapted to determine the desired distance on the basis of the temperature value, in particular also in addition to the above-named taking account of the f-number. It is thus possible that, for instance, temperature-induced changes to the flange focal distance due to thermal expansion and/or temperature-induced focal length changes of the objective can be compensated. The temperature in the interior of the camera, of a camera housing or of the closer environment of the camera can be detected with the aid of the temperature sensor, for example.

In accordance with a further advantageous embodiment of the invention, the control unit furthermore has a calibration value signal input for receiving at least one flange focal distance calibration value, with the control unit furthermore being adapted additionally to determine the desired distance value between the objective mount and the image sensor on the basis of the at least one flange focal distance calibration value. The taking into account of the flange focal distance calibration value can in particular also take place in addition to the above-explained taking account of the f-number, of the filter element recognition value and/or of the temperature value. It is possible by the taking account of a flange focal distance calibration value also to use those objectives with the camera which require a different flange focal distance. Such differences in the flange focal distance can result, for example, on the basis of production tolerances. A further reason for such differences can comprise the objective originally having been designed for a different camera with a different flange focal distance. The flange focal distance calibration value can be determined with the aid of a suitable procedure and can be stored in a memory device which is or can be connected to the control unit, for example in an objective data memory provided at the objective.

Further advantageous embodiments of the invention are set forth in the dependent claims, in the description and in the drawings.

The invention will be described in the following with reference to an embodiment and to the drawings. There are shown:

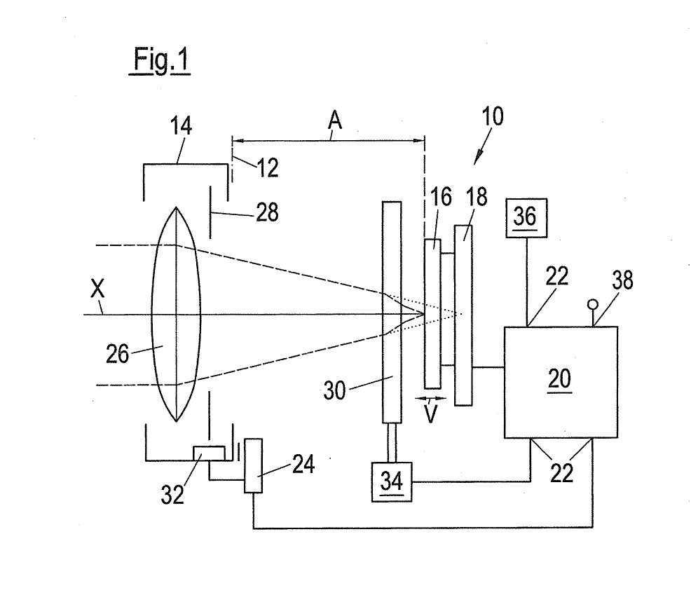

FIG. 1 a schematic representation of a digital camera in accordance with the invention in accordance with an embodiment; and

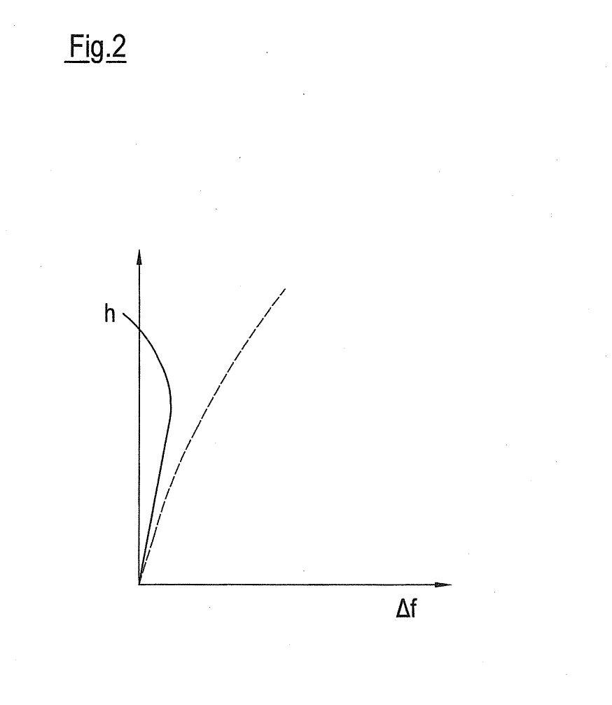

FIG. 2 a schematic representation of a course of spherical aberration of an objective.

A digital camera 10 in accordance with the invention, in particular a motion picture camera (movie camera), comprises an objective mount 12 to which an objective 14 is connected. The objective 14 is here shown purely schematically with a single lens 26 and an adjustable objective diaphragm 28 for setting different f-numbers. In principle, the objective 14 can also have a plurality of lenses which are arranged with a fixed focal length or with a variable focal length.

The camera 10 furthermore comprises an image sensor 16, with the objective 14 and the image sensor 16 being arranged along an optical axis X. The image sensor 16 is coupled to an adjustment apparatus 18, for example to a piezo element. The image sensor 16 can be displaced along the optical axis X in an adjustment direction V indicated by a double arrow with the aid of the adjustment apparatus 18. The distance between the objective mount 12 and the image sensor 16, in particular the flange focal distance in accordance with the distance A between a contact plane for the objective 14 defined by the objective mount 12 and the image plane of the sensor 16, can be adjusted by the displacement of the image sensor 16. The camera 10 can have a housing (not shown) which supports the objective mount 12 and which accommodates the image sensor 16 and the adjustment apparatus 18 as well as further components of the camera 10.

A filter element 30, for example an optical low pass filter, a neutral density filter, an ultraviolet filter or an infrared filter, is further more selectively provided in the optical path between the objective 14 and the image sensor 16.

The camera 10 furthermore comprises a control unit 20 which has a plurality of operating parameter signal inputs 22 and which is connected to the adjustment apparatus 18. The control unit 20 calculates a desired distance value in dependence on operating parameter values which are received at the operating parameter signal inputs 22 and it controls the adjustment apparatus 18 to set the named distance A to the calculated desired value. This will be explained in more detail in the following.

One of the operating parameter signal inputs 22 is connected to an objective data interface 24 which is provided at the objective mount 12 and which is in turn connected to an f-number sensor 32 provided at the objective 14 for detecting the f-number set at the objective diaphragm 28.

A second operating parameter signal input 22 is connected to a filter element detector 34 which is adapted to generate a filter element recognition value and to transfer it to the control unit 20 when the named filter element 30 is present in the region between the objective mount 12 and the image sensor 16. The filter element detector 34 can furthermore be adapted to detect information on the kind of filter element 30 and/or on at least one optical property of the filter element 30 and to transfer this information to the control unit 20 as the filter element recognition value. The named information can, for example, be the thickness and/or the refractive index of the filter element 30. The filter element detector 34 can, for example, comprise an optical, mechanical or electrical sensor and/or contact.

A third operating parameter signal input 22 is connected to a temperature sensor 36 of the camera 10 which is configured to determine the temperature of the camera 10 and to transfer it to the control unit 20 as an operating parameter value.

Finally, the control unit 20 has a calibration value signal input 38 which is adapted to receive at least one flange focal distance calibration value. The flange focal distance calibration value can be determined by a single calibration of the camera ex works with the aid of a suitable test routine and/or can be determined by a subsequent calibration and can be stored in an associated memory device (not shown) which is or can be connected to the calibration value signal input 38.

The operation of the camera 10 in accordance with the invention will be explained in more detail in the following.

As was already initially mentioned, real objectives have spherical aberration which results in a displacement of the image point in dependence on the ray height at which the rays generating the respective image point pass through the objective.

The corresponding relationship is shown in general qualitatively in FIG. 2. The image point displacement Δf along the optical axis is entered on the X axis of FIG. 2 in dependence on the ray height, with the dashed curve indicating the image point displacement for an uncorrected objective and the solid curve indicating the image point displacement for a corrected objective, i.e. for an objective having an optical correction of the spherical aberration (e.g. by use of additional lenses). Whereas the spherical aberration only has slight effects with a diaphragm aperture set very small, i.e. if only a very small image point displacement Δf takes place, the spherical aberration with a larger diaphragm aperture (in accordance with a larger ray height h and a smaller set f-number) results in a larger image point displacement Δf, with the individual image points being distributed over a specific region along the optical axis in dependence on the ray height h of the rays generating them. With an uncorrected objective (dashed curve), an even larger image point displacement Δf results for an even larger diaphragm aperture, whereas with a corrected objective (solid curve), the image point displacement Δf becomes smaller again as the ray height increases and finally even adopts a negative value. The position and extent of the effective back focal length range thus varies in both cases in dependence on the set f-number.

As explained above, a distance A or flange focal distance at which the image sharpness on the image plane of the image sensor 16 is optimum overall exists for every f-number. This optimum flange focal distance can be determined by calculation or by way of experiment and can be stored in the control unit 20 in the form of an algebraic equation or as a look-up table.

The flange focal distance A can thus be set in dependence on the f-number set at the objective diaphragm 28 and detected by means of the f-number sensor 32 with the aid of the adjustment apparatus 18 such that an optimum image sharpness is always achieved. It is thereby possible, for example, to set the focus of the objective 14 solely on the basis of a distance value of a distance scale present at a focusing ring of the objective 14, with this distance value corresponding to the distance of an object to be imaged as sharp by the camera. It is ensured in this respect by the additional adaptation of the flange focal distance A that the set focus for all f-numbers ensures a sharp imaging of the object. I.e. a change of the f-number without any change of the set distance value (rotational position of the focusing ring) also automatically results in a corresponding adjustment of the flange focal distance A to compensate the variation of the image point displacement Δf shown in FIG. 2.

With digital cameras 10, a filter element 30 is often introduced into the optical path between the objective 14 and the image sensor 16 to improve the image quality. Such filter elements 30 frequently comprise a planoparallel plate which results in a parallel offset of the incident light rays in dependence on their angle of incidence. As shown not-to-scale in FIG. 1, such an offset likewise results in an image point displacement, with the amount of the offset depending on the angle of incidence of the light rays onto the filter element 30 and thus inter alia also on the ray height.

In principle, the presence of a filter element can be taken into account on the calculation and construction of a corresponding objective. Frequently, however, such objectives should also be used in cameras which are not designed for the presence of filter elements in the ray path. This means, again with reference to FIG. 2, that such an objective is admittedly optically corrected in accordance with the solid curve so that the image point displacement Δf only varies to a relatively small degree with the ray height h in comparison with an uncorrected objective. This correction is, however, disturbed on a presence of a filter element in the ray path such that the filter element effects a much more noticeable variation of the image point displacement Δf with the ray height h than shown by the solid curve in FIG. 2. With the camera 10 in accordance with the invention in accordance with FIG. 1, there is the possibility of compensating the presence of a filter element 30. A corresponding filter element-related operating parameter value or filter element recognition value can be detected with the aid of the filter element detector 34 and can be transmitted to the control unit 20. The taking into account of the corresponding filter element recognition value can in turn take place on a calculation or experimental base. In particular, not only the filter recognition value can be taken into account as the only operating parameter value, but additionally also the set f-number or the desired f-number can be taken into account as a further operating parameter value.

However, it must be noted that the filter element detector 24 is not absolutely necessary. A compensation is also possible and sensible in the case of a fixedly installed filter element 30. In this case, information on the presence of a fixedly installed filter element 30 can be permanently stored in the control unit 20 so that the control unit 20 also takes account of the presence of the fixedly installed filter element 30 in the calculation of the desired distance value (between the objective mount 12 and the image sensor 16) in dependence on the named f-number.

Finally, due to changes in the operating temperature or in the environmental temperature of the camera 10, further image point displacements can be produced which require an adaptation of the flange focal distance A. For this purpose, the temperature value detected by the temperature sensor 36 can be taken into account on the setting of the desired distance value alternatively or additionally to the f-number and/or to the filter recognition value.

### REFERENCE NUMERAL LIST

10 camera
12 objective mount
14 objective
16 image sensor
18 adjustment apparatus
20 control unit
22 operating parameter signal input
24 objective data interface
26 lens
28 objective diaphragm
30 filter element
32 f-number sensor
34 filter element detector
36 temperature sensor
38 calibration value signal input
A flange focal distance, distance
V adjustment direction
X optical axis

1. A digital camera (10) comprising:
an objective mount (12) for connecting an objective (14);
an image sensor (16), with the image sensor (16) and the objective (14) being arranged along an optical axis (X) of the camera (10);
an adjustment apparatus (18) which is adapted to adjust the distance (A) between the objective mount (12) and the image sensor (16) along the optical axis (X); and
a control unit (20) having at least one operating parameter signal input (22) for receiving at least one operating parameter value of the camera (10) or of a connected objective (14),
wherein the control unit (20) is adapted to determine a desired distance value between the objective mount (12) and the image sensor (16) on the basis of the at least one operating parameter value and to control the adjustment apparatus (18) to set the distance (A) between the objective mount (12) and the image sensor (16) to the desired distance value.

2. A camera in accordance with claim 1,
wherein the adjustment apparatus (18) is adapted to displace the image sensor (16) along the optical axis (X).

3. A camera in accordance with claim 2,
wherein the maximum displacement distance of the image sensor (16) amounts to at most 250 μm.

4. A camera in accordance with claim 1,
wherein the adjustment apparatus (18) comprises at least one piezo element.

5. A camera in accordance with claim 1,
wherein the control unit (20) is adapted to determine the desired distance value such that an image sharpness of an object (14) imaged on the image sensor (16) is at a maximum for a given focal setting of the objective (14).

6. A camera in accordance with claim 1,
wherein the at least one operating parameter value comprises a set f-number or a desired f-number of a connected objective (14).

7. A camera in accordance with claim 6,
wherein the control unit (20) is adapted to determine the desired distance value such that an image sharpness of an object imaged on the image sensor (16) is at a maximum for the set f-number or for the desired f-number of the connected objective (14).

8. A camera in accordance with claim 6,
wherein an objective data interface (24) is provided at the objective mount (12) of the camera (10) and wherein the at least one operating parameter signal input (22) of the control unit (20) is connected to the objective data interface (24) to receive the set f-number from the connected objective (14).

9. A camera in accordance with claim 8,
wherein the at least one operating parameter value comprises a focal length value of the connected objective (14) in addition to the set f-number.

10. A camera in accordance with claim 6,
wherein the at least one operating parameter signal input (22) of the control unit (20) is adapted to receive the desired f-number of the connected objective (14) from an external objective control unit which controls the connected objective (14) from external.

11. A camera in accordance with claim 6,
wherein the camera (10) comprises a filter element (30) between the objective holder (12) and the image sensor (16).

12. A camera in accordance with claim 1,
wherein the at least one operating parameter value comprises a filter element recognition value, with the camera (10) comprising at least one filter element detector (34) which is adapted to generate the filter element recognition value when a filter element (30) is present in a region between the objective mount (12) and the image sensor (16) and with the at least one operating parameter signal input (22) of the control unit (20) being connected to the filter element detector (34) to receive the filter element recognition value.

13. A camera in accordance with claim 12,
wherein the filter element detector (34) is furthermore adapted to detect information on the kind of filter element (30) or on at least one optical property of the filter element (30), with the filter element recognition value comprising this information.

14. A camera in accordance with claim 1,
wherein the at least one operating parameter value comprises a temperature value, with the camera (10) comprising a temperature sensor (36) which is adapted to generate the temperature value on the basis of a detected temperature and with the at least one operating parameter signal input (22) of the control unit (20) being connected to the temperature sensor (36) to receive the temperature value.

15. A camera in accordance with claim 1,
wherein the control unit furthermore has a calibration value signal input (38) for receiving at least one flange focal distance calibration value, with the control unit (20) furthermore being adapted to determine the desired distance value between the objective mount (12) and the image sensor (16) in addition to the at least one operating parameter value on the basis of the at least one flange focal distance calibration value.
